(19) United States
(12) Patent Application Publication
(10) Pub. No.: US 2013/0262218 A1
(43) Pub. Date: Oct. 3, 2013

(54) Incorporating Delayed Feedback In Performance-Based Content Distribution

(71) Applicants: Xuerui WANG, Palo Alto, CA (US); Jason HSUEH, Menlo Park, CA (US)

(72) Inventors: Xuerui WANG, Palo Alto, CA (US); Jason HSUEH, Menlo Park, CA (US)

(73) Assignee: Google Inc.

(21) Appl. No.: 13/436,831

(22) Filed: Mar. 30, 2012

(51) Int. Cl. G06Q 30/02

(52) U.S. Cl. 705/14.43

(57) ABSTRACT

Systems, methods, and computer-readable medium allow incorporation of delayed feedback in performance-based content delivery. A computer-implemented method includes receiving historical data indicative of performance of at least one first content item, determining a statistical distribution of the performance over time, applying the statistical distribution to a second content item to obtain an estimated performance of a second content item over time, and determining a pricing value of the second content item based on the estimated performance.

### BACKGROUND

The Internet provides access to a wide variety of resources, such as video files, audio files, pictures, business and personnel contact information, product information, maps, and news articles. Access to these resources presents business opportunities such as advertising opportunities.

### SUMMARY

In illustrative implementations, a computer-implemented method includes: receiving, at a processing circuit, historical data indicative of performance of at least one first content item; determining, using at least one processing circuit, a statistical distribution of the performance over time; applying the statistical distribution to a second content item to obtain an estimated performance of a second content item over time; and determining a pricing value of the second content item based on the estimated performance.

In some implementations, the method includes receiving a bid on the second content item based on the pricing value.

In some implementations, the method includes hierarchical Dirichlet smoothing of the statistical distribution.

In some implementations, the second content item includes an advertisement as part of an ad campaign, and the method includes adjusting the ad campaign based on the estimated performance of the advertisement. In some implementations, the adjusting includes optimizing the ad campaign based on both the estimated performance and observed performance of the advertisement. The method may include warranting the estimated performance to be equal or better than the observed performance.

In some implementations, the historical data are selected from a window of time. The method may include rejecting data outside the window.

In another aspect, a computer-readable storage medium is provided having instructions stored thereon for execution by at least one processing circuit for distributing online content items. In some implementations, the instructions include: receiving historical data indicative of performance of at least one first content item; determining a statistical distribution of the performance over time; applying the statistical distribution to a second content item to obtain an estimated performance of a second content item over time; and determining a pricing value of the second content item based on the estimated performance.

In some implementations, the instructions include receiving a bid on the second content item based on the pricing value.

In some implementations, the instructions include hierarchical Dirichlet smoothing of the statistical distribution.

In some implementations, the second content item includes an advertisement as part of an ad campaign, and the instructions include adjusting the ad campaign based on the estimated performance of the advertisement. In some implementations, the adjusting includes optimizing the ad campaign based on both the estimated performance and observed performance of the advertisement. The instructions may include warranting the estimated performance to be equal or better than the observed performance.

In some implementations, the historical data are selected from a window of time. The instructions may further include rejecting data outside the window.

In another aspect, an online content distribution system is provided including at least one processing circuit. In some implementations, the at least one processing circuit is configured to: receive historical data indicative of performance of at least one first content item; determine a statistical distribution of the performance over time; apply the statistical distribution to a second content item to obtain an estimated performance of a second content item over time; and determine a pricing value of the second content item based on the estimated performance.

In some implementations, the at least one processing circuit is configured to receive a bid on the second content item based on the pricing value.

In some implementations, the at least one processing circuit is configured to perform hierarchical Dirichlet smoothing of the statistical distribution.

In some implementations, the second content item includes an advertisement as part of an ad campaign, and the at least one processing circuit is configured to adjust the ad campaign based on the estimated performance of the advertisement.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, implementations, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the disclosure may be shown exaggerated or enlarged to facilitate an understanding of the disclosure. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 is a diagram illustrating an example of a content requesting and rendering system, such as in an advertising environment.

FIG. 2 is a block diagram of an example of a web page of a publisher, including a plurality of advertisements including contextual advertisements and user advertisements, as appeared on a viewer's screen.

FIG. 3 is a block diagram of an example of a web page that may be generated by a page assembly operation of an advertisement consumer, for rendering on a viewer's screen.

FIG. 4 is a diagram illustrating delayed conversions in response to online clicks to an advertisement.

FIG. 5 is a flowchart illustrating some examples of the various operations.

FIG. 6 is a block diagram illustrating an example feedback loop for an ad campaign.

FIG. 7 is a block diagram illustrating an example of a computer system that can be used to perform at least some of the various operations.

### DETAILED DESCRIPTION

Below are more detailed descriptions of various concepts related to, and implementations of, inventive methods and systems for taking into account delayed feedback in content delivery operations. It should be appreciated that various concepts introduced above and discussed in greater detail below may be implemented in any of numerous ways, as the disclosed concepts are not limited to any particular manner of implementation. For example, although an advertising environment is used as an example to realize the methods and systems of the described implementations, the methods and systems are not limited to advertising, but may be applied to any other content. Examples of specific implementations and applications are provided primarily for illustrative purposes.

A web page such as a search result page provided by a search engine server, or any web page provided by a publisher, can include slots in which alternative content items (e.g., advertisements) can be presented. These advertisement slots can be defined in the web page or defined for presentation with a web page, for example, as part of the web page, or in a pop-up window, for presentation to users. As used herein, a “user” may refer to an identifier of an individual user, a user device, a user browser, etc., and does not necessarily refer to the actual individual user. The identifiers may include cookies, for example. The cookies can include activity data for more than one user, and one user can have several cookies (e.g., on different machines, different browsers, different times, etc.). Users may opt out of data collection, and users may opt in to data collection to provide additional demographic data for improved online experience, including receiving content items of interest. The identifiers associated with user data may be anonymized and/or not connected to user names or actual identifies, or other sensitive information, such as random identifiers.

Advertisement slots can be allocated to content item providers, such as advertisers, through an auction. For example, advertisers can provide bids specifying monetary amounts that the advertisers are respectively willing to pay for presentation of their advertisements. In turn, an auction can be performed and the advertisement slots can be allocated to advertisers according to their bids. When one advertisement slot is being allocated in the auction, the advertisement slot can be allocated to the advertiser that provided the highest bid or a highest auction score (e.g., a score that may be computed as a function of a bid and/or an advertisement quality measure, where the advertisement quality measure can be how well the content of the advertisement matches searches for certain keywords). When multiple advertisement slots are allocated in a single auction, the advertisement slots can be allocated to a set of bidders that provided the highest bids or advertisements having the highest auction scores.

The advertising can be part of Internet marketing (also known as online marketing, web marketing, or e-marketing). The effectiveness of online marketing can be measured by cost per impression (CPI), or cost per thousand impressions (CPM), where an impression may be counted, for example, whenever an advertisement server counts a loading on an advertisement at a user's device. Some of the impressions lead to clicking on the advertisement, and a click-through rate (CTR) may be defined as the number of clicks on the advertisement divided by the number of impressions.

Some of the user identifiers visiting the web page may take a desired action beyond simple browsing (impression) of the web page. The desired actions may include, for example, buying a product from the web page, joining a membership, opening an account, subscribing a newsletter, downloading an application, user identifiers referring the advertisement to other user identifiers, etc. The percentage of such visitors taking the desired actions may be referred to as the conversion rate (Cvr). Thus, advertisement pricing sometimes can be determined by cost per action (CPA). Correspondingly, the advertisement pricing may be measured as cost per click-through (CPC; counted when an advertisement is clicked), cost per sale (CPS), and cost per lead (CPL). Sometimes an effective CPM (eCPM) may be used to measure the effectiveness of an advertisement, where actual actions such as clicks may be factored into the calculation of the CPM described above.

An advertisement campaign generally refers to an advertising activity, such as delivering specifically relevant ads to user identifiers in certain geographical locations, delivering specifically relevant ads to different product lines, or delivering specifically relevant ads to certain user identifier groups. Campaign information may include, for example, one or more budgets for one or more time periods (e.g., a daily budget), geographical information, syndication preference information, start and end dates of the campaign, etc.

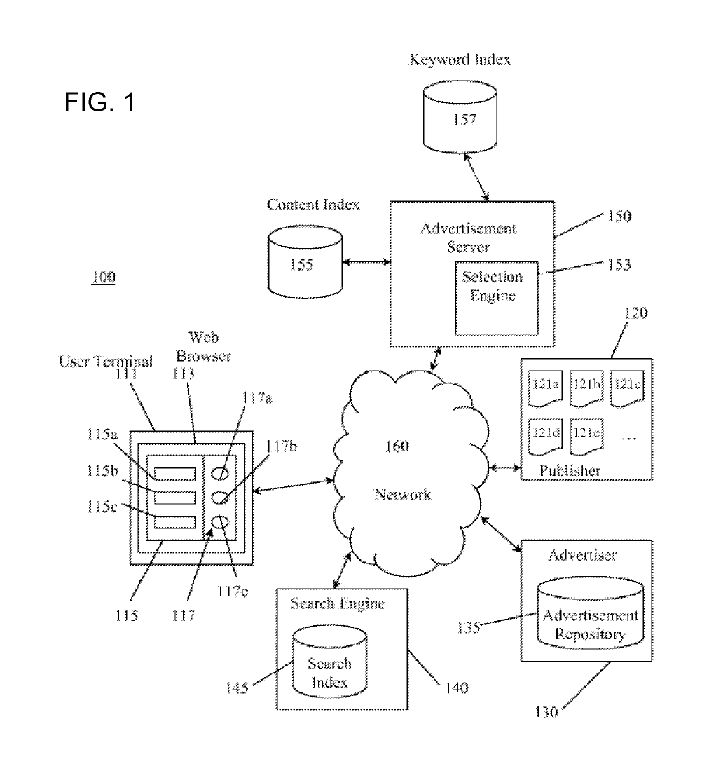

FIG. 1 illustrates an example of a system 100 for distributing content, such as web page content, search results, and alternative content items such as advertisements. The system 100 may include a user terminal 111, represented by a user identifier, to which content is distributed, and a publisher 120 that provides content 121a-121e, such as web pages, that include space to which alternative content can be distributed.

A search engine provider 140 may be operable to assist users in finding desired content in response to user-generated search queries using a search index 145 stored on one or more storage devices. The system 100 may also include a content provider 130, such as an advertiser, that provides alternative content for distribution to user terminals, and a content server 150 for selecting alternative content (e.g., advertisements) distribution to available spaces included in publishers' content, or other requested content.

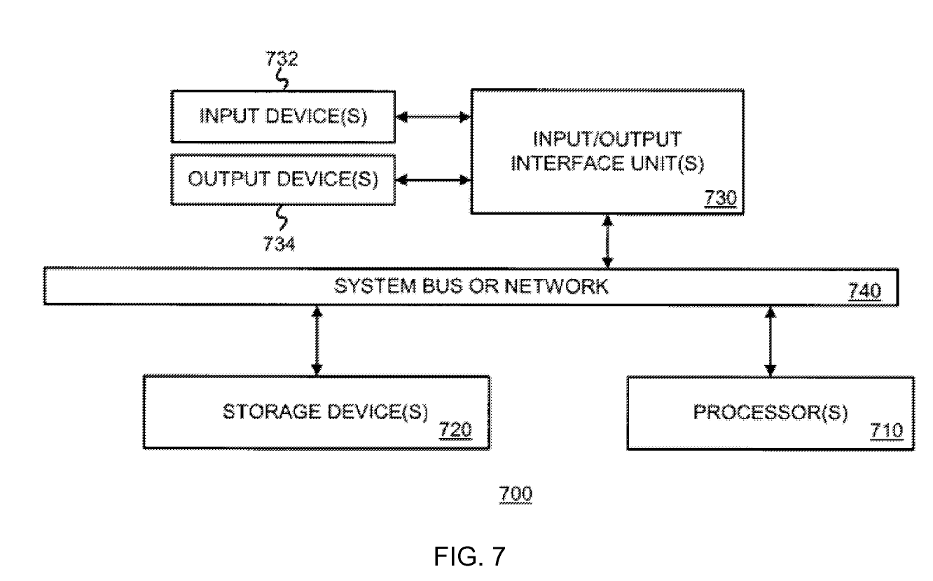

One or more of the components of the system 100, such as the user terminal 111, the publisher 120, the content provider 130, the search engine provider 140, and/or the content server 150, can include or be connected to one or more computer systems, as described in detail below with respect to FIG. 7.

The user terminal 111 can include a personal computer, a mobile device, and/or another computing device capable of communicating with the publisher 120, the content provider 130, the search engine provider 140, and/or the content server 150 via the network 160 and capable of displaying content, including selected alternative content, to a user. In some implementations, the user terminal 111 includes a user interface 113, such as a web browser program, that is operable to output a display to the user and/or to receive inputs from the user, such as keystrokes, pointer clicks, voice commands, and/or another inputs. The display of the user interface 113 can include a first area 115 for display of content 115a-115c from a first source, such as search results provided by the search engine provider 140 or the web page 121a provided by the publisher 120.

The display of the user interface 113 can also include a second area 117 for display of alternative content 117a-117c from a second source, such as advertisements selected by the content server 150 from among available advertisements provided by one or more content providers 130.

The publisher 120 can include a server computer or another computing device that may include a storage device on which the pieces of content 121a-121e are stored. The publisher 120 can receive requests for content from the user terminal 111 and to transmit one or more computer files and/or data streams in response to each request. In some implementations, the pieces of content 121a-121e may include current contexts of web pages, which are transmitted to the user terminal 111 in response to a real-time request over the network 160, which may include the Internet.

The user interface 113 can process the computer files and/or data streams to create an audio/visual display of the content of a requested web page or other resource. One or more of the computer files and/or data streams may include one or more instructions that, when processed by the user terminal 111, can cause the user terminal 111 to request one or more alternative content items from the content server 150.

In response to receiving the request for alternative content, a selection engine 153 of the content server 150 selects an appropriate number of pieces of content for distribution to the user terminal 111 from among candidate pieces of content referenced in one or more indices, such as indices 155 and 157. In some implementations, the index 157 may be a keyword-based index that can be used to select alternative content items based on keywords included in the request, and the index 155 may be a content-based index which can be used to select alternative content items based on the content 115a-115c requested from the publisher 120, as indicated in the request for alternative content.

With respect to selecting one or more alternative content items in response to a request for alternative content, the content server 150 can operate based on third-party publishing and/or based on online searching. In other implementations, however, the content server 150 can select alternative content in other ways.

Generally, the content-based index 155 may include references between available alternative content items and locations associated with publishers' content, such as web page addresses for web pages 121a-121e. The references may be determined by the content server 150 based on contextual relationships between the publishers' content available at the locations and available pieces of alternative content. The context of the publishers' content and the available pieces of alternative content may be determined based on an analysis of the content of each performed by the content server 150. For example, in an advertising environment, a copy of a web page 121a may be parsed to identify the context of the web page 121a from text, hypertext links, metadata of images, audio data, video data, and other content included in the web page 121a. Additionally, other signals, such as a frequency of occurrence of a text phrase, or whether the text phrase appears as a title, can be used in determining the context of the web page 121a. Many other signals may also be used in determining the context of the web page 121a, including information provided by the publisher.

The context of available advertisements can also be determined, and matching contexts can be indicated in the content-based index 155. Additionally, or alternatively, other signals of contextual relevance can be used to determine the context of the advertisements, such as historical performance information regarding user identifier interaction with the advertisements and the contexts of the web pages on which the advertisements appeared when an interaction occurred.

In a simple example, the content-based index 155 may include, for each web page, such as the web page 121a, a ranked list of advertisements to be delivered to a reserved advertisement area of the web page. The ranked list can be updated, such as when the content of the web page changes and/or as advertisements are added or removed from the index, or as the context of the advertisements change.

The keyword-based index 157 also generally can include references between the available pieces of alternative content and the publishers' content. Advertisements for distribution to the web page may be selected from among the identified advertisements that have bids for keywords matching those included in the request or associated with the web page.

Regardless of the specific operation processes of the content server 150, an indication of the selected alternative content may be transmitted to the user terminal 111 in response to the request for alternative content. If the content provider 130 is an advertiser, the storage device 135 may include an advertisement repository. In some implementations, the content files or data associated with the candidate pieces of alternative content can be stored on a storage device of the content server 150.

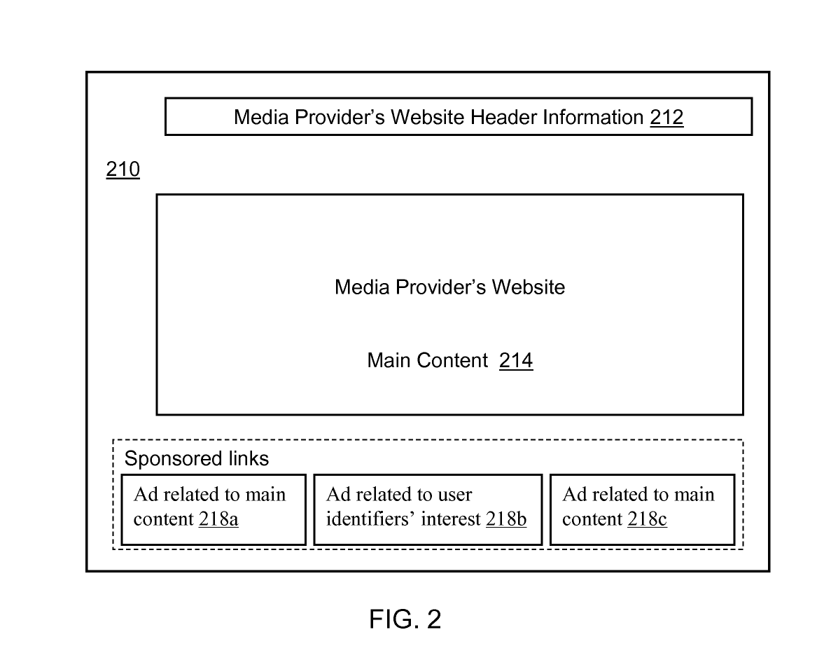

In many different environments, content providers such as advertisers may want to distribute content to selected user identifiers for review. For example, advertisers may want to distribute their advertisements where the advertisements will be effective in communicating information to receptive recipients, and at times when the advertisements will lead to desired activity, such as a purchase of the advertiser's goods or services. FIG. 2 shows an abstract illustration of a display page 210 that may be provided by a publisher (media provider). The example display page 210 may include header information 212 (e.g., the name of the media provider), main content 314, and a plurality of advertisements 218a, 218b, and 218c. Advertisements 218 may be shaded, labeled as “Advertisements” or “Sponsored Links,” and placed on a side or portion of the display page 210. Although FIG. 2 shows only three advertisements 218, various implementations may have more or less advertisements.

Some content providers/advertisers may rely on contextual information when making decisions regarding content distribution selections. As illustrated in FIG. 2, advertisements 218a and 218c may be such contextual advertisements, and may be contextually related to the main content 214. For example, advertisers may want to advertise goods and/or services relating to travel where information of general interest to travel enthusiasts is available, and may prefer to have their advertisements shown based on the fact that the display page 210 is related to travel.

Some other advertisers may prefer relying on specified information, such as interests associated with user identifiers based on browsing histories, or demographic information associated with the user identifiers, when selecting advertisements for distribution. Of course users may opt out of data collection, or may optionally provide additional demographic data. In general, at least the user identifiers may be anonymized and not connected with user names to protect the privacy of the users. In an example, an advertisement 218b may be shown based on the user's historical behavioral data provided by the data provider. The display of the advertisement 218b may not be in response to an express indication of a topic of interest associated with the user identifier such as the current view of the web site or a submission of a search query. In this implementation, third-party advertising may be implemented with historical behavioral data. Some of the advertisements 218 may be related to the user's current interest (e.g., the current context of the main content of the display page 210 which the user identifier is browsing). Some other of the advertisements 218 may be related to other interest derived from the historical behavioral data associated with the user identifier.

In some other implementations, the alternative content is not limited to advertising, but can be any content. Additionally, content providers can rely on performance information regarding results achieved by previous content distribution selections.

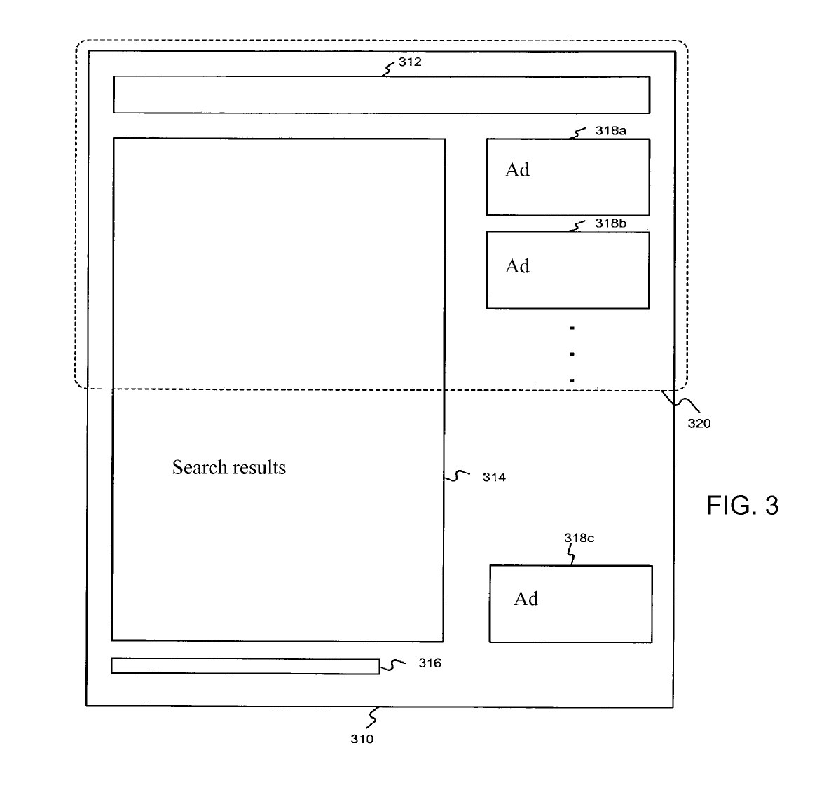

In some other implementations, the search engine may combine the search results with one or more of the advertisements. This combined information including the search results and advertisement(s) can then be forwarded towards the user that requested the content, for presentation to the user. For example, FIG. 3 shows an abstract illustration of a display page 310 that may be provided by the search engine. In this case, the search engine provider is the publisher/media provider. The outline 320 depicted with dashed lines corresponds to a portion of the display page 310 that is currently viewed on a display screen of the user terminal, sometimes referred to as the viewport. The example display page 310 may include header information 312 (e.g., the name of search engine host), trailer information 316 (e.g., copyright, navigational hypertext links, etc.), a plurality of search results 314 and a plurality of advertisements 318a, 318b, and 318c.

Content delivery systems such as performance-based Internet advertising systems may seek to optimize advertisers' returns. However, statistics such as conversions may take a long time (e.g., about a month for some campaigns) to be performed or reported and to be incorporated in determining the ad performance. This is because the end users may need time to make a decision to convert, as compared with clicks that take little time, and either occur or don't occur during the web page visit or browsing session. This phenomenon may be referred to as a conversion delay.

It may be possible to wait such a long period (e.g., a month), and then conduct the update in a feedback loop to determine the ad performance. However, during the long delay such as the month, the competition landscape of the advertising industry might already have changed dramatically, and a decision resulting from such a delayed feedback may be outdated, resulting in less effective advertising strategies.

Although advertising systems may constantly evaluate the tradeoff between the timely update and accurate feedback, most conversion-driven advertising systems take incomplete statistics as input to the feedback loop. Such advertising systems may underestimate the effectiveness of campaigns with long conversion delays.

A simplified example can be used to illustrate the above point. For example, an ad campaign has a target CPA of $10. On a specific day (e.g., January 1), the campaign spends 100 dollars, and receives five conversions on the same day. The campaign further receives five conversions on January 2, five conversions on January 3, three conversions on January 4, and two conversions on January 5. If an update in a standard feedback loop is based on the incomplete conversion statistics on January 1, the observed CPA would be $20 (i.e., $100/5), which is much higher than the specified target CPA, $10. The competitiveness in CPC auction of this campaign may have to be lowered to hopefully meet the target CPA while lowering the spending. However, in a long run, actually 20 conversions are received for the $100 spent on January 1. As such, a $5 CPA is realized, which is well below the $10 target CPA. Thus, the competitiveness actually should be increased aggressively to increase spending while still meeting the target CPA specified. As such, it can be seen that incorrect decisions may be made based on the incomplete statistics.

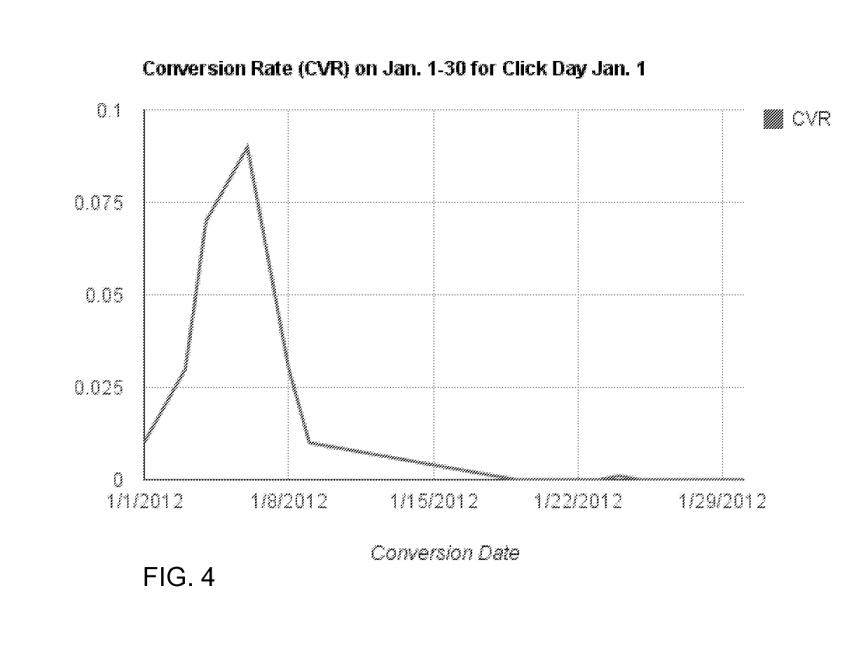

FIG. 4 is a simplified drawing illustrating an example Cvr (normalized) in a one-month period in response to clicks at the beginning of the month. The delayed response and the long tail in the response are apparent.

Many advertising campaigns are conversion driven. Unlike a click that could happen shortly after an impression, a conversion may have significant delay after a click event is recorded, as illustrated in FIG. 4.

Although the conversion delay may be within a few days for some campaigns, for some other campaigns, the delay may be much longer. According to some of the described implementations, a window of the time can be preselected to determine the conversions associated with the clicks. In an example, a window of 30 days is selected, and conversions after the 30-day window may be considered not associated with the click, and those data may be rejected. In some other implementations, different windows can be selected according to faster or slower conversion responses, due to different types of products, different industries, different campaigns, and so on.

As such, the conversion delay poses a barrier for performance driven systems that rely on timely update with feedback, such as feedback regarding conversions. Instead of waiting for 30 days, it may be possible to take the observed conversions so far (e.g., within a couple of days) to update the system. However, as illustrated in FIG. 4, relying only on the first couple of days' data may underestimate the total conversions. For campaigns with long delays, such a practice may lead to a large variance in bidding (e.g., resulting in aggressive bid cut) in the early life of a campaign.

According to some of the described implementations, historical statistics may be leveraged, in addition to the (incomplete) data observed in real time. The system can still have a swift feedback loop. For example, when updating the system, the number of conversions in the next 30 days may be predicted, and these expected conversions may be used as the feedback to the advertising system in real time. The expected conversions may be calculated on a campaign level according to some implementations, or on other levels according to some other implementations.

In an example, historical data of campaigns similar to the example described above are employed, and an estimate can be made for the new campaign. For example, it may be estimated that January 1 will have 5.2 conversions, January 2 will have 5.1 conversions, January 3 will have 4.9 conversions, January 4 will have 3.2 conversions, January 5 will have 1.8 conversions, and January 6 will have 0.5 conversions. In total, an estimated 20.7 conversions may be expected for the $100 spent on January 1. As such, the feedback loop can be updated based on the $4.83 expected CPA. Although the estimate might not be entirely accurate, it is still more informative than using the observed conversion data of January 1, which would lead to an incorrect decision.

In general, the relationship between clicks and responses (such as conversions resulting from the clicks) may be described mathematically. Table 1 lists notations used for the mathematical descriptions below.

TABLE 1

| Symbol | Description |
|---|---|
| ConversionsByDay_{d,i} | # of conversions on i^{th} day after click |
| | day d, where i ε {0, 1, . . . , 30}. |
| DelayedCvrᵢ | conversion rate on i^{th} day after click day, where |
| | i ε {0, 1, . . . , 30}. |
| Clicks_{d} | # of clicks on click day d. |
| ExpectedConvs_{d,t} | # of expected conversions of click day d at time t, |
| | where t > d. |
| ObservedConvs_{d,t} | # of observed conversions of click day d at time t, |
| | where t > d. |
| FinalConvs_{d} | # of final conversions for click day d, |
| | = ObservedConvs_{d,d+30}. |
| Error_{d,i} | Error of expected conversion on i^{th} day after click |
| | day d, where i ε {0, 1, . . . , 30}. |
| α ε (0,1) | Decay factor in exponential smoothing when |
| | accumulating data over a period. |

For example, for a current day d, expected delayed Cvrs based on data in the past 90 days ([d−90, d−1]) may be calculated as:

$${DelayedCvr}_{i} = \frac{{\sum }_{j = 1}^{90 - i} {α}^{90 - j - i} {ConversionsByDay}_{d - 90 + j - 1 , i}}{{\sum }_{j = 1}^{90 - i} {α}^{90 - j - i} {Clicks}_{d - 90 + j - 1}} , \\ where , \\ 0 \leq i \leq 30$$

In some implementations, historical data of one or more campaigns of an advertiser may be used to provide the estimate for a new campaign for the same advertiser, and different granularity of the data can be employed. For example, at the most fine-grained level, data from a closely-related campaign can be used for a new advertisement. At a higher level, data from a number of campaigns within the same category can be used for the estimate of a new campaign within this category. It may be noted that using data across different advertisers may have privacy or competition issues. However, so long as different advertisers opt in to employing the data across different advertisers, a larger sample of historical data can be used.

At a canonical level, the data may be tagged by advertisers, or by user identifiers (e.g., enterprise user identifiers, generic user identifiers). The data can be made orthogonal, for example, for data related to showing an advertisement to a first user identifier, the system would make sure that the same advertisement was not shown to a second user identifier.

According to some implementations, with abundant historical data and advanced smoothing techniques, the expected conversions can be estimated with a very high precision.

For campaigns with short conversion delays, using expected conversions can lead to more accurate updating, thus helping reduce the exploration cost in performance-based advertising systems. Conversion data can be sparse or even non-existing for new campaigns. In some implementations, a hierarchical Dirichlet smoothing framework may be employed to alleviate the lack of data. Even for new campaigns, it is still possible to estimate the expected conversions fairly accurately with this framework. Significantly increased revenue from campaigns with long conversion delays may be achieved, while the efficiency of the advertising network can be improved.

The methods can be used in any other performance-based systems where delayed feedback is available. Other areas of applications and systems, particularly those with long feedback loops due to delays can benefit from the described implementations. For example, the hierarchical Dirichlet smoothing framework can be a good solution in dealing with the lack of data in various systems/applications. The lack of data (e.g., sparsity) may result from particularities of certain campaigns, or because a campaign is new.

In some implementations, smoothing of the data may be performed with all levels, e.g.,

$$Smoothed Delayed Cvr = \frac{\begin{matrix}Clicks \times {DelayedCvr}_{campaign} + 100 \times {DelayedCvr}_{customer} + \\ 20 \times {DelayedCvr}_{canonical \_ customer} + 10 \times {DelayedCvr}_{global}\end{matrix}}{Clicks + 100 + 20 + 10} .$$

In some other implementations, data from the higher levels may only be incorporated in smoothing when there is insufficient traffic at the finer-grained levels. For example, if Clicks>1000, then smoothing may not be employed. If Clicks<=1000, then smoothing may be employed. For example, if Clicks<=200, then smoothing may incorporate the customer level data. If after the customer level smoothing Clicks<100, then the smoothing may incorporate the canonical customer level data. If after the canonical customer level smoothing Clicks<20, then the smoothing may incorporate the global level data. The different levels may be used to illustrate a hierarchy in the statistics of the data. For example, a global level may be considered the root level; a canonical customer may be considered the first level; a customer level may be considered the second level; and the campaign level may be considered the third level. In this example, only parts of the above equation for the Smoothed Delayed Cvr may be employed, depending on the level for smoothing.

In some implementations, for a click day, the system may start with the smoothed clicks at conversion day 0, and use it as the smoothing threshold for all conversion days. As used herein, the “smoothed clicks” may indicate the number of clicks after a smoothing operation. For example, there may be 905 clicks at the campaign level, and 100 smoothing clicks at the customer level (fixed for every campaign). As such, there would be 1005 smoothed clicks. Another example for smoothed clicks is the denominator in the above equation, i.e., “Clicks+100+20+10.” In some implementations, a separate smoothed click may be introduced for every conversion day, and smoothing may be performed for different conversion days independently.

In some implementations, since for new campaigns there may not be observed data for later conversion days, higher-level delayed conversions may be directly copied over without any changes. By leveraging the observed relationship (represented as a scaling factor) from lower-level conversions and higher-level conversions in early conversion days, the copied conversions may be adjusted by a scaling factor for later conversion days. This adjustment may be based on the assumption that the conversion delay does not change even if the conversion rate changes.

The expected conversions for click day d at day d+i may be of interest, where iε{0, 1, . . . , 30}. The ExpectedConvs_{d,d+i} may be calculated as follows:

$${ExpectedConvs}_{d , d + i} = {ObservedConvs}_{d , d + i} + {Clicks}_{d} \times {\sum }_{j = i + 1}^{30} {DelayedCvr}_{j}$$

As shown above, in some implementations, the real-time observed conversions may always be honored, and it may be guaranteed that ExpectedConvs_{d,d+i}>=ObservedConvs_{d,d+i}.

To measure how accurate the expected conversions are, an error can be defined as:

$${Error}_{d , i} = \frac{{FinalConvs}_{d} - {ExpectedConvs}_{d , d + i}}{{FinalConvs}_{d}}$$

An example offline analysis workflow for expected conversion accuracy may be described as follows:

1. Conversion-logged campaigns may be stored in a database, so that equivalent campaign expansion may be based on the database and limited to conversion-logged campaigns.

2. Customer and canonical customer pairs may be collected into a table, and customers may be fetched under a canonical customer. Such pairs may be generated daily, for example.

3. Campaign and customer pairs may be collected into a table so that campaigns may be fetched under a customer quickly.

4. Multiple versions of delayed conversions (with each version corresponding to a processing day) may be constructed, and stored in a separate table.

5. Higher level (such as customer level) delayed conversions may be put under a campaign. For any campaign, all levels of delayed conversions may be stored in the same table. At the end, all levels of delayed conversions could be retrieved by the campaign. If the delayed conversions have multiple versions, all versions may be processed and the timestamp of delayed conversions may be observed when mapping it to a different level.

6. Expected conversions may be calculated with different versions of delayed conversions and with different smoothing mechanisms.

7. The expected conversions may be reviewed in the above step and the overall accuracy may be reported.

The processing time may not necessarily coincide with the day boundary, and thus not all conversions for that conversion day may have been observed at the processing time. As such, special handling (e.g., interpolation) may be employed to take into account the partial days.

For the expected conversions for a click day d at time d+i+p, where iε{0, 1, . . . , 30} and pε(0,1) corresponding to the partial day, ExpectedConvs_{d,d+i+p} may be calculated in several different ways.

In a first example, ExpectedConvs_{d,d+i+p}=ObservedConvs_{d,d+i+p}.

In a second example,

$${ExpectedConvs}_{d , d + i + p} = {ObservedConvs}_{d , d + i + p} + {Clicks}_{d} \times ( {DelayedCvr}_{i} \times ( 1 - p ) + {\sum }_{j = i + 1}^{30} {DelayedCvr}_{j} ) .$$

For most campaigns, the conversions do not come in uniformly. This calculation may become over optimistic if an interpolation happens for a day when most conversions come in unevenly in an early portion of the day d+i.

In a third example, it may be defined that A=Min

$$( {ObservedConvs}_{d , d + i + p} + {Clicks}_{d} \times {DelayedCvr}_{i} \times ( 1 - p ) , {Clicks}_{d} \times {\sum }_{j = 0}^{i} {DelaedCvr}_{j} ) ,$$

where a relatively conservative approach may be adopted to honor the expected conversions calculated from history. However, as it may be needed to honor the observed conversions, a maximum can be defined B=Max (ObservedConvs_{d,d+i+p}, A). As such,

$${ExpectedConvs}_{d , d + i + p} = B + {Clicks}_{d} \times {\sum }_{j = i + 1}^{30} {DelayedCvr}_{j} .$$

The above calculation may suffer from a subtle shift in conversion time when the conversions occur around the day boundary. For example, for a click day d with 100 clicks, it may have DelayedCvr₅=0.2, DelayedCvr₆=0.05, ConversionsByDay_{d,5}=24 and ConversionsByDay_{d,6}=1. Overall, the actual conversions reflect what the history indicates. However, in an example, 4 conversions at 12:30 am on day d+6 shifted to 11:50 pm on day d+5, which would make the prediction overly optimistic. Without statistics at finer levels, the calculation may become unsatisfactory.

In a fourth example, it may be defined that and

$$C = A + {Clicks}_{d} \times {\sum }_{j = i + 1}^{30} {DelayedCvr}_{j} ,$$

the observed conversions may be honored in a different way, e.g., ExpectedConvs_{d,d+i+p}=Max(ObservedConvs_{d,d+i+p}, C).

This may address the issue discussed above, that is, the system may compensate for unusually large observed conversions across day boundaries from following days. For example, if many conversions are observed in an early portion of a day, fewer would be expected later. However, this solution may not be very accurate when i is small. Because the observed conversion in early days is unlikely to beat C, the results may be dominated by C, and the observed conversions may contribute very little or nothing to the final expected conversions.

In a fifth example, the expected conversions may be calculated as:

$${ExpectedConvs}_{d , d + i + p} = Max ( {ObservedConvs}_{d , d + i + p} , \frac{{ObservedConvs}_{d , d + i + p} + A}{2} + {Clicks}_{d} \times {\sum }_{j = i + 1}^{30} {DelayedCvr}_{j} ) ,$$

which may be considered a combination of the previous two calculations. The Max function may guarantee that ExpectedConvs_{d,t}≧ObservedConvs_{d,t}.

In a sixth example, the expected conversions may be calculated as an average of those in the second and third examples:

$${ExpectedConvs}_{d , d + i + p} = \frac{\begin{matrix}B + {Clicks}_{d} \times {\sum }_{j = i + 1}^{30} {DelayedCvr}_{j} + \\ Max ( {ObservedConvs}_{d , d + i + p} , C )\end{matrix}}{2} .$$

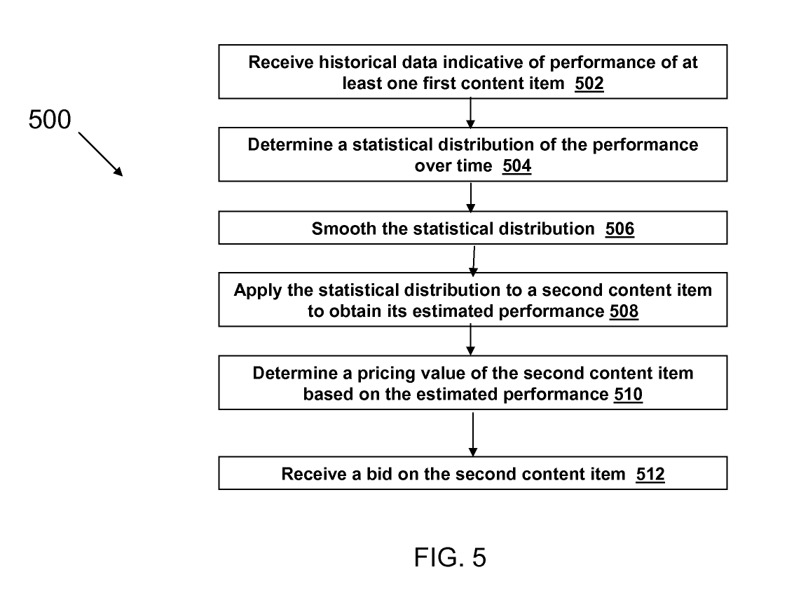

FIG. 5 is a flowchart illustrating a computer-implemented method 500 associated with some of the abovementioned implementations. In an operation 502, one or more processing circuit (e.g., that of the advertisement server 150 shown in FIG. 1) may receive historical data indicative of performance of at least one first content item (e.g., conversions in response to an advertisement over a period of time of an ad campaign).

In an operation 504, a statistical distribution of the performance of the at least one first content item may be obtained as a function of time. The statistical distribution may be smoothed in an operation 506 if needed.

In an operation 508, the statistical distribution may be applied to a second content item (e.g., a new ad in a new campaign) to obtain its estimated performance. Such an estimated performance may be used to determine a pricing value of the second content item. In an operation 512, bids may be received on the second content item, and the advertisement ranking may be determined based on the pricing value and the bid in an auction process.

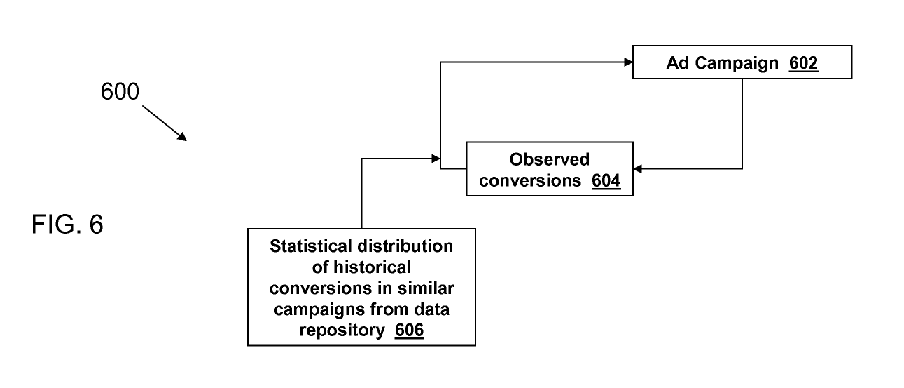

FIG. 6 is a block diagram illustrating a feedback loop 600 according to some of the described implementations. An ad campaign 602 may result in a number of responses (e.g., conversions) over time. The observed conversions 604 may be fed back to the ad campaign 602, so that the campaign may be adjusted/optimized based on the feedback. The observed conversions 604 may be significantly delayed in response to an online action (such as ad click or ad impression). For example, the observed conversions may be a distribution over time, such as the curve illustrated in FIG. 4. Thus, real-time feedback may not be obtained from the observed conversions 604. On the other hand, historical conversion data of similar or related campaigns may be obtained from a data repository. A statistical distribution of the historical data may be obtained, and used to estimate the performance of the ad campaign 602. Such an estimated performance may be added to the feedback loop, to allow an almost real-time feedback. Based on such a feedback, parameters (criteria) for the ad campaign 602 may be adjusted, thereby achieving an optimal campaign.

FIG. 7 is a high-level block diagram of a computer-based system 700 that may perform one or more of the operations discussed above. The system 700 may include a processor or processing circuit 710, an input/output interface unit 730, a storage device 720, and a system bus or network 740 for facilitating the communication of information among the coupled elements. An input device 732 and an output device 734 may be coupled with the input/output interface 730.

The processor 710 may execute machine-executable instructions stored on, for example, a tangible computer-readable medium, or a non-transitory computer-readable medium to perform one or more aspects of the present disclosure. At least a portion of the machine executable instructions may be stored (temporarily or more permanently) on the storage device 720 and/or may be received from an external source via an input interface unit 730.

The one or more input and/or output devices 750 may include a communication device for operable connection with a network 160 and with the other components of the system 100 as illustrated in FIG. 1. The one or more computer systems 700 can perform the various functions of the components of the system 100 by executing computer-readable instructions, such as computer software stored on a computer-readable storage device.

In some implementations, the user terminal 111 as illustrated in FIG. 1 may be part of the system 700 or may be connected to the system 700. The user terminal 111 may include one or more conventional personal computers, including one or more of a mobile device, a smart phone, a personal digital assistant (PDA), a tablet computer, or a camera that can connect to the system 700 or to the Internet.

The processor 710 may be one or more microprocessors. The bus 740 may include a system bus. The storage device 720 may include system memory, such a read only memory (ROM) and/or random access memory (RAM). The storage device 720 can include any suitable type of storage including, for example, a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or any other type of storage medium.

A user identifier may enter commands and information into the personal computer through input device 732, such as a keyboard and pointing device (e.g., a mouse) for example. Other input devices such as a microphone, a touch input interface, a joystick, a game pad, a satellite dish, a scanner, or the like, may also (or alternatively) be included. These and other input devices can be connected to the processor 710 through an appropriate interface 730 coupled to the system bus or network 740.

The output device 734 may include a monitor or other types of display devices, which can be connected to the system bus 740 via an appropriate interface. In addition (or instead of) the monitor, the personal computer may include other (peripheral) output devices (not shown), such as speakers and printers for example. In some cases, output device 734 can include a component for providing one or more of a visual output, a haptic output, or an audio output.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the disclosure can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A computer-implemented method of distributing online content items, the method comprising:
receiving, at a processing circuit, historical data indicative of performance of at least one first content item;
determining, using at least one processing circuit, a statistical distribution of the performance over time;
applying the statistical distribution to a second content item to obtain an estimated performance of a second content item over time; and
determining a pricing value of the second content item based on the estimated performance.

2. The computer-implemented method of claim 1, further comprising receiving a bid on the second content item based on the pricing value.

3. The computer-implemented method of claim 1, further comprising hierarchical Dirichlet smoothing of the statistical distribution.

4. The computer-implemented method of claim 1, wherein the second content item comprises an advertisement as part of an ad campaign, the method further comprising adjusting the ad campaign based on the estimated performance of the advertisement.

5. The computer-implemented method of claim 4, wherein the adjusting comprises optimizing the ad campaign based on both the estimated performance and observed performance of the advertisement.

6. The computer-implemented method of claim 5, further comprising warranting the estimated performance to be equal or better than the observed performance.

7. The computer-implemented method of claim 1, wherein the historical data are selected from a window of time.

8. The computer-implemented method of claim 7, further comprising rejecting data outside the window.

9. A computer-readable storage medium storing instructions thereon for execution by at least one processing circuit for distributing online content items, the instructions comprising:
receiving historical data indicative of performance of at least one first content item;
determining a statistical distribution of the performance over time;
applying the statistical distribution to a second content item to obtain an estimated performance of a second content item over time; and
determining a pricing value of the second content item based on the estimated performance.

10. The computer-readable storage medium of claim 9, wherein the instructions further comprise receiving a bid on the second content item based on the pricing value.

11. The computer-readable storage medium of claim 9, wherein the instructions further comprise hierarchical Dirichlet smoothing of the statistical distribution.

12. The computer-readable storage medium of claim 9, wherein the second content item comprises an advertisement as part of an ad campaign, the instructions further comprising adjusting the ad campaign based on the estimated performance of the advertisement.

13. The computer-readable storage medium of claim 12, wherein the adjusting comprises optimizing the ad campaign based on both the estimated performance and observed performance of the advertisement.

14. The computer-readable storage medium of claim 13, wherein the instructions further comprise warranting the estimated performance to be equal or better than the observed performance.

15. The computer-readable storage medium of claim 9, wherein the historical data are selected from a window of time.

16. The computer-readable storage medium of claim 15, where the instructions further comprise rejecting data outside the window.

17. An online content distribution system comprising at least one processing circuit configured to:
receive historical data indicative of performance of at least one first content item;
determine a statistical distribution of the performance over time;
apply the statistical distribution to a second content item to obtain an estimated performance of a second content item over time; and
determine a pricing value of the second content item based on the estimated performance.

18. The system of claim 17, wherein the at least one processing circuit is further configured to receive a bid on the second content item based on the pricing value.

19. The system of claim 17, wherein the at least one processing circuit is further configured to perform hierarchical Dirichlet smoothing of the statistical distribution.

20. The system of claim 17, wherein the second content item comprises an advertisement as part of an ad campaign, and wherein the at least one processing circuit is further configured to adjust the ad campaign based on the estimated performance of the advertisement.
